(19) United States
(12) Patent Application Publication
(10) Pub. No.: US 2015/0182898 A1
(43) Pub. Date: Jul. 2, 2015

(54) RIDGID POROUS PLASTIC FILTERS INCORPORATING POLYMERIC PARTICLES AND POLYMERIC FIBERS

(71) Applicant: BHA Altair, LLC, Franklin, TN (US)

(72) Inventors: Vishal Bansal, Overland Park, KS (US); Bryan David Yetter, Kearney, MO (US)

(21) Appl. No.: 14/144,665

(22) Filed: Dec. 31, 2013

(51) Int. Cl. B01D 46/24

(52) U.S. Cl. CPC B01D 46/2403

(57) ABSTRACT

A rigid filter for filtering particulate from a flowing fluid. The filter includes sintered polymer particles, with the polymer particles having a melt temperature. The filter includes fibers of material having a melt temperature higher than the melt temperature of the polymer particles. The polymer particles and the fibers are intermixed. A plurality of adhesion points are among the plurality of polymer particles. The plurality of adhesion points include melt fusion points and the plurality of adhesion points fix the polymer particles relative to each other to provide a rigid structure entrapping the fibers. A plurality of pores extends between the particles and fibers so as to allow fluid flow through the rigid filter. The fixed polymer particles block particles within the fluid during the flow of the fluid though the filter.

### FIELD OF THE INVENTION

The present invention relates generally to a filter. In particular, the present invention relates to a filter having improved construction and function.

### BACKGROUND OF THE INVENTION

There is increasing environmental regulatory control throughout the world. Much of the regulatory control is focused on reducing air-borne pollutants and emissions from certain industrial sources, such as power plants and materials production facilities. A known technique to control the pollutants and emissions from the industrial sources is to separate undesirable particulate matter that is carried in a gas stream by fabric filtration. Such fabric filtration is accomplished in a dust collection apparatus known in the industry as a “baghouse.”

The baghouse typically includes a housing divided into two plenums by a tube sheet. One plenum is a “dirty air” plenum which communicates with an inlet and receives “dirty” or particulate laden gas from a source at the plant. The other plenum is a “clean air” plenum which receives cleaned gas after filtration and communicates with an outlet to direct cleaned gas away from the baghouse. A plurality of relatively long cylindrical fabric filters, commonly called “bags,” are suspended from the tube sheet in the dirty air plenum. Each bag has a closed lower end and is installed over a cage. Each bag is mounted to the tube sheet at its upper end and hangs vertically downward into the dirty air plenum. The upper end portion of the bag is open and the interior of each bag is in fluid communication with the clean air plenum.

In operation, particulate laden gas is conducted into the dirty air plenum. As the particulate laden gas flows through the baghouse, the particulates carried by the gas engage the exterior of the fabric filter bags and accumulate on or in media of the fabric filter bags or are separated from the gas stream and fall into an accumulator chamber at the lower portion of the dirty air plenum. Cleaned gas then flows through the media of the fabric filter bags, into the interior of the fabric filter bags, to the clean air plenum and through the outlet. Although many baghouses are made according to this basic structure, there may be numerous operational and structural differences among baghouses.

There is interest in replacing known fabric filter bags. Some possible benefits to fabric bag replacement include improvements in filtering efficiencies, improvements in cost, and improvements in durability.

Sintered polymer holds at least some possibility as a viable approach as a possible replacement to fabric filter bags. The sintered polymer is porous and thus could be used as a filter material. However, the inventors have become aware that particulate (e.g., dust) can penetrate into the sintered polymer and become lodged therein. With the particulate (e.g., dust) lodged therein, the sintered polymer would lose efficiency, cause undesirable pressure rise and/or have a shortened life if used as a filter material. As such there is still currently desire/interest in improvements to filters (e.g., alternatives to fabric filter bags), and there may be current questions about the viability of sintered polymer for use as a filter material. Also, although sintered polymer may have some beneficial uses as a filter material, it has been noted by the inventors that pressure drop may be an issue to address. Accordingly, there is a need in the industry for improvements in filter structure.

### BRIEF SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some aspects of the invention in a simplified form as a prelude to the more detailed description that is presented later.

In accordance with one aspect, the present invention provides a rigid filter for filtering particulate from a flowing fluid. The filter includes sintered polymer particles, with the polymer particles having a melt temperature. The filter includes fibers of material having a melt temperature higher than the melt temperature of the polymer particles. The polymer particles and the fibers are intermixed. A plurality of adhesion points are among the plurality of polymer particles. The plurality of adhesion points include melt fusion points and the plurality of adhesion points fix the polymer particles relative to each other to provide a rigid structure entrapping the fibers. A plurality of pores extends between the particles and fibers so as to allow fluid flow through the rigid filter. The fixed polymer particles block particles within the fluid during the flow of the fluid though the filter.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic section view of a first example filter, with sintered polymer and fibers, in accordance with an aspect of the present invention;

FIG. 2 is schematic view of an example mold for creation of a filter in accordance with an aspect of the invention;

FIG. 3 is a schematic view of an example heat treating oven for heat treating a filter in accordance with an aspect of the invention;

FIG. 4 is a schematic view of an example chemical treatment unit for chemically treating a filter in accordance with an aspect of the invention

FIG. 5 is a schematic illustration showing an example processing step used to make a filter in accordance with an aspect of the present invention;

FIG. 6 is a schematic illustration of a filter having potted end caps in accordance with an aspect of the present invention;

FIG. 7 is a schematic illustration of an example filter house within which example filters, in accordance with an aspect of the present invention, are utilized;

FIG. 8 is a schematic end view of a third example filter having an ovoid cross-section, in accordance with an aspect of the present invention;

FIG. 9 is a schematic end view of a fourth example filter having a star cross-section, in accordance with an aspect of the present invention;

FIG. 10 is a schematic end view of a fifth example filter having a triangle cross-section, in accordance with an aspect of the present invention; and

FIG. 11 is a schematic end view of a sixth example filter having a pleated shape, in accordance with an aspect of the present invention.

### DESCRIPTION OF EXAMPLE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

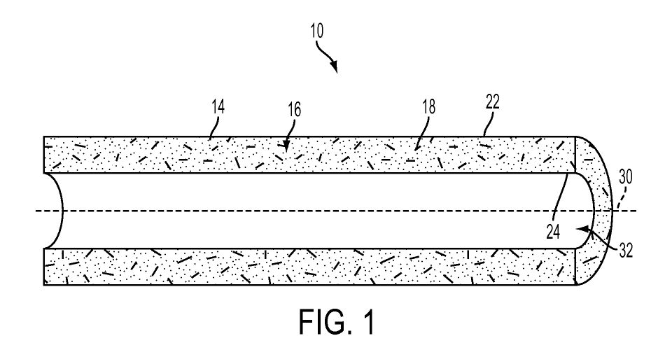

A first example filter 10, in accordance with an aspect of the present invention, is schematically shown within FIG. 1. The filter 10 includes a combination of sintered polymer (e.g., plastic) granules or particles 14 and fibers 18 of material having a melt temperature higher than the melt temperature of the polymer particles. Specifically, the sintered polymer particles 14 with the fibers 18 intermixed is provided as being rigid and as having a plurality of pores 16 between adjacent particles/fibers.

It is to be appreciated that in view of the porosity of the filter 10, fluid (e.g., air) can flow through the filter 10. However, dependent upon porosity, pore size, etc., at least some particulate matter that is entrained within the fluid is blocked (i.e., filtered out) from the fluid as the fluid flows through the filter 10. It is to be appreciated that the type, amount, etc., of the particulate that is filtered out can be related to the porosity, pore size, etc. of the filter 10.

It is to be appreciated that it is the flow of fluid through the filter 10 is associated with the filtering action. As such, there is a flow from one (e.g., a first) side 22 to another (e.g., a second) side 24 of the filter 10. In some respects, the first side 22 of the filter 10 can be considered to be a “dirty” side and the second side 24 can be considered to be a clean side. Also, the two sides 22, 24 can be defined/dependent upon the shape/configuration of the filter 10, and/or the flow direction of the fluid. Within the shown example of FIG. 1, the shape of the filter 10 is a cylinder that extends about and along an axis 30, with the first side 22 being an outer cylindrical surface (i.e., faces outward away from axis 30) and the second side 24 being an inner cylindrical surface (i.e., faces inward toward axis 30). Thus, fluid flow is radially inward to a hollow interior 32 of the cylinder shape of the filter 10. Of course, it is to be appreciated that other shapes/configurations are contemplated.

Turning to the construction of filter 10, in accordance with one aspect, the filter is provided via mixing (e.g., blending) higher melt point fibers 18 with the polymer particles 14 prior to the polymer particles being sintered. Specifically, the melt point of the fibers 18 is higher than the melt point of the polymer particles 14. The inclusion of higher melt point fibers results in increasing the porosity of the sintered porous plastic structure.

The mixing of the fibers 18 with the polymer particles 14 can be a random mixing. As such, the distribution of the fibers 18 throughout the filter 10 is overall considered to be even or consistent. Specifically, the distribution through the thickness is considered to be even or consistent. Also, the distribution through other dimensions of the filter 10 is considered to be even or consistent. However, it is contemplated that many different types of distribution to provide many different effects could be utilized. For example, the fibers 18 can be added (i.e., mixed-in) only in selected locations. Such may be considered to be a focused intermixing or combination of fibers 18 with the polymer particles 14. Some specific examples include: adding, mixing-in and/or concentrating the fibers 18 only at/near the outer side 22 and/or only at/near the inside surface 24.

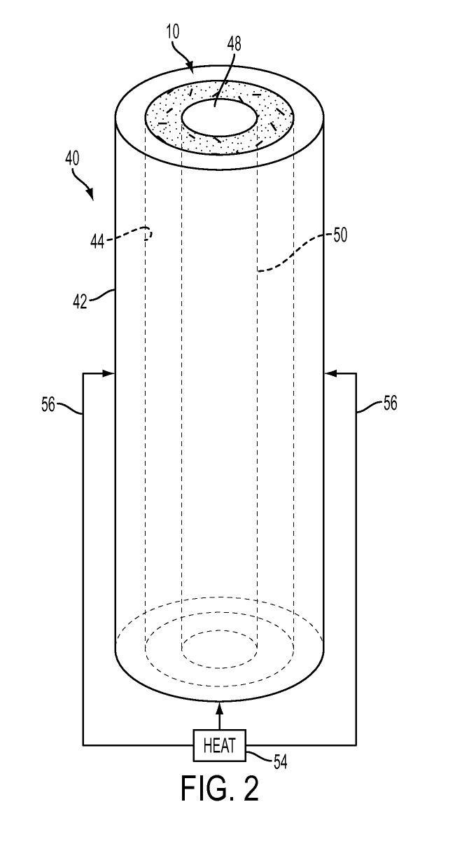

Turning to the construction of the example of FIG. 1, attention is directed to the example mold 40 shown in FIG. 2 for creation of a filter (e.g., 10) in accordance with an aspect of the invention. It is to be appreciated that the example mold 40 could be used to create the example filter 10. Also, it is to be appreciated that other molds and/or other arrangements could be used to create the example filter 10. Still further, for example filters having other constructions/configurations (i.e., non-cylindrical) still other molds and/or other arrangements could be used for filter creation.

The mold 40 has an outer mold portion 42, which may be comprised of multiple pieces for filter release. The outer mold portion 42 has an inner cylindrical surface 44, which is configured to create the outer surface 22 of the filter 10 during the filter creation process. The mold 40 has an inner mold portion 48, which is akin to a spindle core. The inner mold portion 48 has an outer surface 50, which is configured to create the inner surface 24 of the filter 10 during the filter creation process.

Associated with the mold 40 is a heat source 54 (schematically shown). The heat source 54 can be of various construction/configuration (e.g., electric heater, gas heater) to heat the mold 40. Heat 56 is provide to the mold 40 so that the heat is causes a diffusion/partial melt of the polymer particles that are introduced into the mold for sintering to create the sintered polymer particles 14. However, heating of the mold 40 is to a temperature approaching but not exceeding the melting point of polymer material of the particles 14, which below the melt temperature of the fibers.

Granules or particles of polymer and the fibers are introduced (e.g., poured if the mold is vertically oriented as shown within FIG. 2) into the mold 40. The mold 40 and thus the particles 14, and the fibers 18 intermixed therein, receive the heat 56. The heat 56 causes the particles 14 to begin to diffuse/melt. But, the fibers 18, with the higher melt point, do not diffuse/melt in the same fashion as the particles. Focusing upon the particles 14, the outer edges/surfaces of the particles 14 initially diffuse/melt. Adjacent particles 14 will diffuse/molten-flow/fuse together. However, before the particles 14 completely melt and thus before the particles 14 completely transition to a fluid state, the heating is creased. The diffused/melted outer edges/surfaces of the particles 14 and the molten-flow/fused together portions thereof will re-solidify. The fibers 18, which have not melted, are entrapped within the resolidified/sintered particles 14. The fused/re-solidified particles 14 and the fibers 18 leave gaps or pores 16 between adjacent particles/fibers. Thus, there is porosity. The fibers 18 help to create pores/porosity that are greater than what would other be accomplished without the fibers. It should be noted that if multiple layers (e.g., possible layers with different particles and/or fibers and/or fiber concentration/distribution) are desired, such could be built-up in successive molding, layering steps.

For the sake of completeness it is to be appreciated that sintering is a method of creation from separate particles (e.g., granules). Sintering is based on atomic diffusion. Diffusion can occurs at various temperatures, but diffusion occurs much faster at higher temperatures. As such, the atoms in adjacent, touching particles diffuse across the boundaries of the particles, fusing the particles together and creating one solid piece. It is to be appreciated that sintering can occur when the heating temperature has not reached the melting point of the polymer.

Turning to some example specifics of the sintered polymer of the particles 14, some examples of the polymers (e.g., plastics) that can be used are ultra-high-molecular-weight polyethylene (UHMWPE), polytetrafluoroethylene (PTFE), polyvinylidene difluoride (PVDF), polyester, polypropylene, nylon, or polyphenylene sulfide (PPS). It is to be appreciated that other polymers could be utilized and that various combinations (i.e., mixtures) of such polymers could be utilized. The polymer granules or particles 14 used to make the sintered layer(s) can have a range of sizes from about 10 micron to 200 microns. It is to be appreciated that other materials and/or size parameters could be utilized and that various combinations (i.e., mixtures) of such materials and/or size parameters could be utilized. Also, different materials/size parameters could be used for different layers.

Turning to some example specifics of the fibers 18, the fibers could be organic or inorganic. Some example materials for the fibers 18 include staple fibers made from PVDF, PTFE, fiberglass, carbon, aramids, polysulfone, or metals. In one example, the fibers 18 could have a softening temperature at least 30° C. higher than the melting point of polymer material of the particles 14. Some examples of fiber length include a range of approximately 0.2 inch (5.08 mm) to 3 inches (76.2 mm). Of course, it is contemplated that other lengths can be used. Some examples of fiber diameter include a range of approximately 5 microns to 50 microns. Of course, it is contemplated that other diameters can be used. It is to be appreciated that other materials and/or size parameters could be utilized and that various combinations (i.e., mixtures) of such materials and/or size parameters could be utilized. Also, different materials/size parameters could be used for different layers/locations.

It is contemplated that various mix ratios of particles 14 and fibers 18, and including sub-mix ratios for specific layers/locations, can be used. In some examples, the ratio(s) of the two of particles 14 and fibers 18 can be optimized based on desired balance of strength, ductility, filtration efficiency, air permeability, and dust release characteristics.

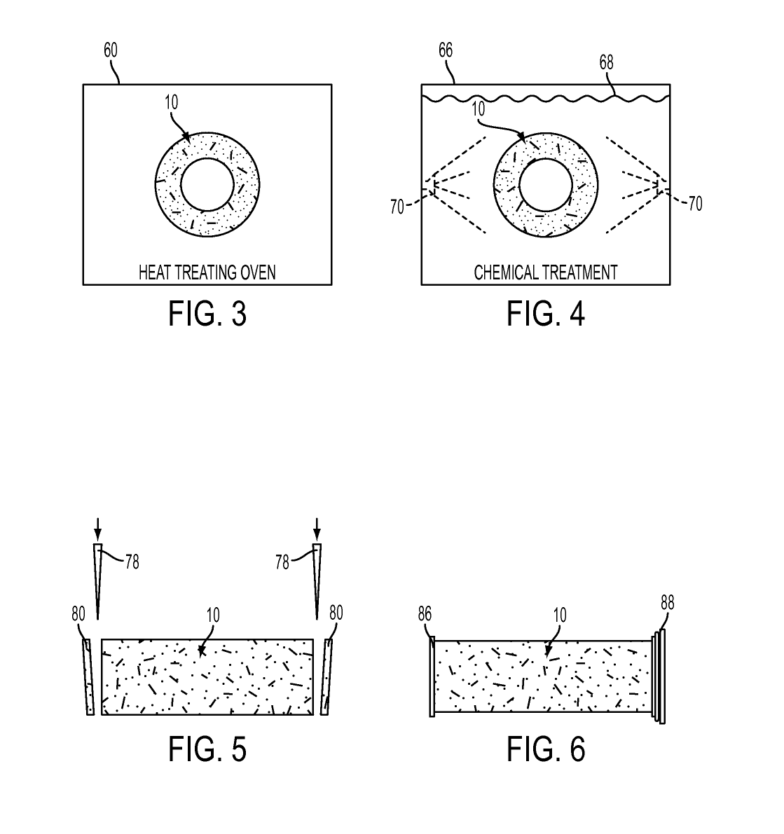

It is to be appreciated that various other, additional or different processes or procedures could be utilized in the creation/processing of the filter 10. One example of additional or different process/procedure is schematically shown in FIG. 3. Specifically, a heat treating oven 60 is schematically shown. The oven 60 is utilized to apply heat to the filter 10 to heat treat the filter. The specifics (e.g., temperature, duration, cycling, etc.) of the heat treating can be varied and may be varied based upon material(s), filter size, filter thickness, particle size, fiber size, etc. Also, the specifics (e.g., temperature, duration, cycling, etc.) of the heat treating can be varied and may be varied to yield desired balance of strength, ductility, and porosity.

Another example of additional or different process/procedure is schematically shown in FIG. 4. Specifically, a chemical treatment structure 66 is shown. The chemical treatment structure 66 is utilized for the application of treating chemical to the filter 10. Within the shown example, the chemical treatment structure 66 shows a fluid level 68 to indicate that the chemical treatment structure 66 may be a vessel or tank, and that the chemical treatment may be via immersion within the fluid chemical. As an alternative to immersion within fluid chemical, spray nozzles 70, shown in phantom to indicate an alternative, may be provided for chemicals that are to be sprayed on for treatment. The specifics (e.g., particular chemical, duration of treatment, cycling, etc.) of the chemical treatment can be varied and may be varied based upon material(s), filter size, filter thickness, particle size, fiber size, etc. In one specific example, a surface oleophobic chemical treatment can be imparted to the filter 10.

Another example of additional or different process/procedure is schematically shown in FIG. 5. Specifically, physical shaping of the created filter 10 is presented within the example of FIG. 5. Within the example, cutting tools 78 are schematically shown which cut axial ends of the cylindrical shaped filter provided via the molding process. Within the schematic representation the arrowheads represent a cutting stroke of the cutting tools 78. The cutting removes portions 80 of the molded filter 10 from the remainder of the filter. The cutting can provide trimming to dimension to a specific axial length, and/or trimming to achieve a certain end profile/face. Of course, it is contemplated that various other processes/procedures can be performed upon the filter 10. For example, another process/procedure that can be performed upon the filter 10 is a machining operation to provide a smooth outer surface finish for better dust release in operation.

Once the various processes/procedures are performed upon the filter 10, various other steps can be performed with the filter. For example, FIG. 6 shown a filter 10 fitted with end plate(s) 86 and/or fitting(s) 88. Each end plate 86 may provide for blocking-off an otherwise open end of the filter 10. Each fitting 88 may provide for securing of the filter into a receiving member or housing. The fitting may include sealing member(s), securing member(s), or the like. Also, the fitting 88 may provide a through aperture that is aligned with the axis 30 of the filter 10 and thus provides an opening for fluid communication with the hollow interior 32 of the filter 10. Accordingly, fluid can flow through the filter 10. The fluid flow is blocked by the end plate 86, but is permitted to flow through the aperture of the fitting 88. The end plate(s) 86 and/or fitting(s) 88 may be secured to the filter 10 in any suitable manner, such as adhesive, potting, mechanical fastener. Also, the filter 10 may be otherwise configured to have closed and open ends (e.g. filter material may form the closed end).

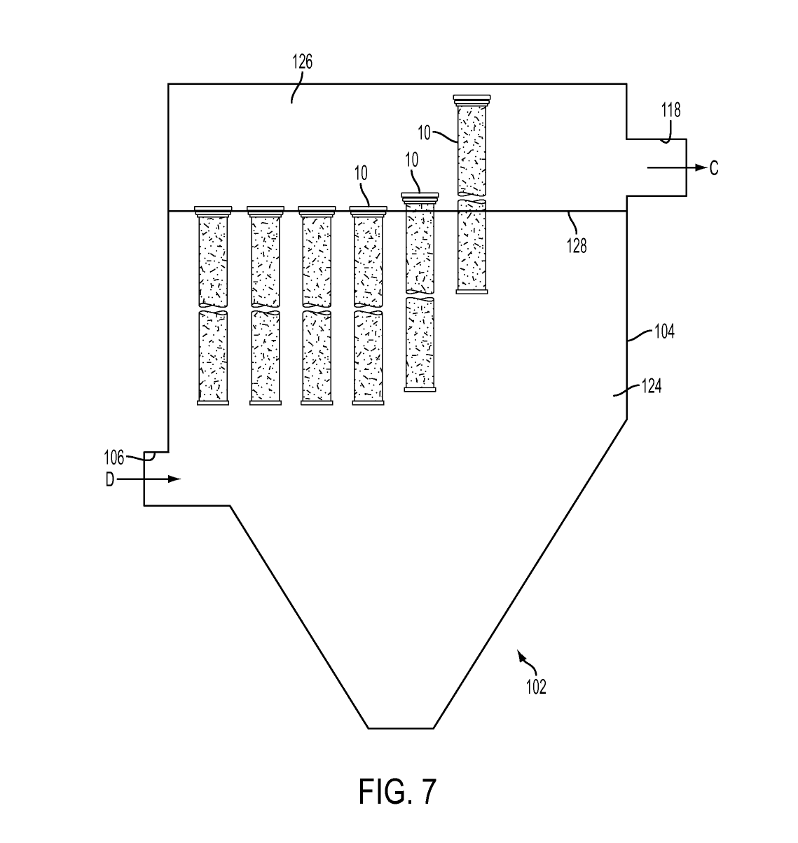

One example device 102 within which one or more filters 10 can be utilized in accordance with an aspect of the present invention is shown within FIG. 7. It is contemplated that one or more filters 10 can be used within various other devices. Turing to the example of FIG. 7, the device 102 can be considered to be a baghouse as bag-type filters could be utilized within the device. However, the filter(s) 10 in accordance with an aspect of the present invention can be utilized in lieu of the bag-type filters as is represented within FIG. 7.

The device (e.g., baghouse) 102 is defined by an enclosed housing 104. The housing 104 is made from a suitable material, such as sheet metal. Particulate laden fluid (e.g., gas such as exhaust gas) D flows into the device 102 at an inlet 106. The particulate laden gas D is filtered by a plurality of the filters 10 located within the device 102. Cleaned gas C exits through an outlet 118 of the device 102.

The device 102 is divided into a “dirty air” plenum 124 and a “clean air” plenum 126 by a sheet 128 made from a suitable material, such as sheet metal. The sheet 128 has at least a portion that is substantially planar. A plurality of openings extend through the planar portion of the sheet 128. A filter 10 is installed in each respective opening, and can optionally extend at least partially through the respective opening. With the example of FIG. 7, plural filters are in the process of being installed, with the last two shown not yet fully engaged into the sheet 128. Also, it is to be appreciated that although only six filters 10 are shown any number (e.g., a large plurality) could be utilized.

It is to be appreciated that the filter(s) 10 in accordance with an aspect of the present invention can be used within various devices. As such, the filter(s) 10 in accordance with an aspect of the present invention is not limited for use within the example device 102 (e.g., a baghouse) as shown within FIG. 7. As one example of yet another device within which the filter(s) 10 in accordance with an aspect of the present invention can be used is a gas turbine inlet filter house. However, even such use is not a limitation upon where the filter(s) 10 in accordance with an aspect of the present invention can be used.

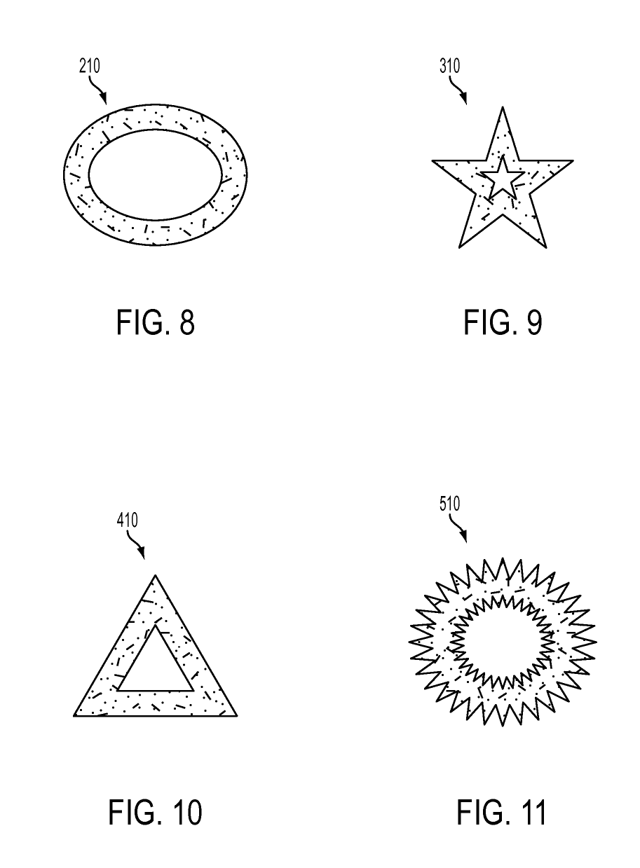

Although the cylinder shape shown with FIG. 1 may provide for ease of replacement of bag-type filters as indicated via the example of FIG. 7, as already mentioned the cylindrical shape of the filter need not be a specific limitation upon the present invention. FIGS. 8-11 provide examples of several other possible shapes for filter tubes. Specifically, FIG. 8 is an end view of a filter 210 having an ovoid (e.g., oval) cross-section shape. FIG. 9 is an end view of a filter 310 having a star cross-section shape. FIG. 10 is an end view of a filter 410 having a triangle cross-section shape. FIG. 11 is an end view of a filter 510 having a pleated shaped cross-section. Each of these filters (e.g., 210) have at least sintered polymer particles and fibers inter-mixed therewith. Of course, different layers, sequences, etc. are possible with these example shapes.

The invention has been described with reference to various example embodiments. Obviously, modifications and alterations will occur to others upon a reading and understanding of this specification. It is intended to include all such modifications and alterations insofar as they come within the scope of the appended claims or the equivalents thereof.

1. A rigid filter for filtering particulate from a flowing fluid, the rigid filter including: sintered polymer particles, with the polymer particles having a melt temperature; and fibers of material having a melt temperature higher than the melt temperature of the polymer particles;
the polymer particles and the fibers being intermixed prior to sintering;
a plurality of adhesion points among the plurality of polymer particles, the plurality of adhesion points include a plurality of melt fusion points and the plurality of melt fusion points fix the polymer particles relative to each other to provide a rigid structure entrapping the fibers, wherein the plurality of fibers are entrapped within the plurality of melt fusion points;
a plurality of pores extending between the particles and fibers so as to allow fluid flow through the rigid filter, the fixed polymer particles blocking particles within the fluid during the flow of the fluid though the filter.

2. The filter as set forth in claim 1, wherein the filter extends about an axis.

3. The filter as set forth in claim 1, wherein the fibers have a softening temperature at least 30° C. higher than the melting point of polymer material of the particles.

4. The filter as set forth in claim 1, wherein the polymer particles include at least one of ultra-high-molecular-weight polyethylene, polytetrafluoroethylene, polyvinylidene difluoride, polyester, polypropylene, nylon and polyphenylene sulfide.

5. The filter as set forth in claim 4, wherein the polymer particles include at least two polymers.

6. The filter as set forth in claim 5, wherein the particles having different polymers are at different locations within the filter.

7. The filter as set forth in claim 1, wherein the polymer particles have a range of sizes from about 10 micron to 200 microns.

8. The filter as set forth in claim 1, wherein the polymer particles have two different ranges of sizes.

9. The filter as set forth in claim 8, wherein the particles having different ranges of sizes are at different locations within the filter.

10. The filter as set forth in claim 1, wherein the fibers are organic.

11. The filter as set forth in claim 1, wherein the fibers are inorganic.

12. The filter as set forth in claim 1, wherein the fibers include at least one of polyvinylidene difluoride, polytetrafluoroethylene, fiberglass, carbon, aramids, polysulfone, or metals.

13. The filter as set forth in claim 12, wherein the fibers include at least two different materials.

14. The filter as set forth in claim 1, wherein the fibers have lengths within a range of approximately 0.2 inch (5.08 mm) to 3 inches (76.2 mm).

15. The filter as set forth in claim 1, wherein the fibers have lengths within two different ranges of sizes.

16. The filter as set forth in claim 15, wherein the fibers having different ranges of sizes are at different locations within the filter.

17. The filter as set forth in claim 1, wherein the fibers have diameters within a range of approximately 5 microns to 50 microns.

18. The filter as set forth in claim 1, wherein the fibers have diameters within two different ranges of sizes.

19. The filter as set forth in claim 18, wherein the fibers having different ranges of sizes are at different locations within the filter.

20. The filter as set forth in claim 1, wherein filter has pleats.
